(19) United States
(12) Patent Application Publication
(10) Pub. No.: US 2005/0193585 A1
(43) Pub. Date: Sep. 8, 2005

(54) Sanitizing cabinet for sports equipment

(76) Inventor: Steve Silver, Cote St-Luc (CA)

Correspondence Address: Eric Fincham, 316 Knowlton Road, Lac Brome, QC, J0E 1V0, CA

(21) Appl. No.: 11/097,722

(22) Filed: Mar. 31, 2005

Related U.S. Application Data
(63) Continuation-in-part of application No. 10/414,683, filed on Apr. 16, 2003, now Pat. No. 6,889,449.
Application No. 10/414,683 is a continuation-in-part of application No. 10/140,398, filed on May 7, 2002, now abandoned.

(51) Int. Cl. F26B 19/00; F26B 25/06; B67D 5/62; F26B 3/00

(52) U.S. Cl. 34/201; 34/490

(57) ABSTRACT

There is provided a method and apparatus for sanitizing sports equipment which comprises a cabinet which can be sealed, first and second conduits in fluid communication with the cabinet, an ozone generator, and fans for circulating ozone containing gas through the conduits into the cabinet, the fans being operative to circulate the ozone containing gas in a first direction and subsequently in a reverse direction. There is also provided a fluid storage device, the fluid storage device being associated with a spray action to spray the fluid into the cabinet after the ozone has been circulated.

The present application is a continuation-in-part of application Ser. No. 10/414,683 filed Apr. 16, 2003 which in turn is a continuation-in-part of application Ser. No. 10/140,398 filed May 7, 2002.

### FIELD OF THE INVENTION

The present invention relates to an apparatus and a method for treating sports gear to sanitize the same.

### BACKGROUND OF THE INVENTION

The problem of odors, mold, and mildew associated with sports equipment is common. Thus, while clothing and apparel can be washed and dried in a normal manner, much equipment cannot be subjected to these processes. For example, in the sport of hockey, skates and protective pads and other paraphernalia cannot be put in commercial washers and dryers. Similarly, shoes and pads from other sports such as soccer and basketball cannot be washed and dried in a conventional manner.

It is known in the art, as shown in U.S. Pat. No. 5,369,893, that one may use self-contained dryers for accommodating sports equipment. The dryers have walls which cause heated air to recirculate in the drying chambers to decrease the moisture content of the air and increase the drying energy efficiency. Blowers and fans associated with electric heaters operate to circulate heated air through the drying chambers.

U.S. Pat. No. 5,369,892 discloses a chest or foot locker structure with a rigid housing wherein the top of the housing has a cover movable to an open position to allow access to the drying chamber. A motor driven fan located in an air mixing chamber within the housing draws air through a filter into the drying chamber. Air porous walls within the drying chamber allow air to mix the drying chamber back to the air mixing chamber for recirculation back into the drying chamber. Air also flows out of the drying chamber through a filter having activated charcoal to remove odors from the air discharged into the environment. This dryer utilizes an internal motor and fan associated with the electric heater and specialized porous walls within a housing.

U.S. Pat. No. 6,134,806 discloses a portable sports equipment bag having an air distributor which is connected with a hose to a blower and ozone generator operable to move air and ozone under pressure into the air distributor. The air distributor's one or more manifolds located within the bag, the manifolds having a plurality of apertures to allow air and ozone in the manifolds to flow into the bag to dry sports equipment and objects within the bag. There are air filters mounted on the bag to remove odors and foreign matters from the air flow from the bag into the environment.

U.S. Pat. No. 6,263,591 discloses a portable sports equipment drying container comprising a body having a cover with an input fan mounted in one of the side walls and an output fan mounted in another one of the walls. The fans are used for drying the moisture wet clothes and equipment placed in the container for circulating air through the container.

However, none of the prior art deals with the necessity of providing a completely sealed enclosure while using ozone for sanitization purposes. In this respect, there are regulations in most countries mandating that ozone cannot be created and vented to the atmosphere.

While the above patents do teach various apparati and methods for attempting to clean and sanitize sports equipment, there exists a need for an apparatus and method which can be used on a commercial basis for sanitizing sports equipment.

### SUMMARY OF THE INVENTION

It is an object of the present invention to provide a method and apparatus which would sanitize sports equipment and which method and apparatus is suitable for use on a commercial basis and is environmentally friendly.

According to one aspect of the present invention, there is provided an apparatus for sanitizing sports equipment which comprises an apparatus suitable for sanitizing sports equipment, the apparatus comprising, a cabinet having an access opening thereto, means for sealing the access opening to provide a substantially airtight container, means for generating ozone, circulation means for causing the ozone to circulate within the cabinet, and spray means for spraying a liquid proximate the circulation means.

The method of using the apparatus of the present invention preferably includes the steps of placing sports equipment within a closed cabinet, circulating ozone containing air in the first direction through the cabinet for a first period of time, circulating the ozone containing air in a second direction opposite to the first direction for a second period of time, maintaining the ozone to have a concentration of at least 20 ppm, and then stopping all circulation of the air and ozone for a period of time sufficient for the ozone to diminish to less than 3 ppm.

Preferably, the cabinet is provided with means for securely sealing the same during the period of time when ozone containing air is within the cabinet. The tight sealing is required to prevent the escape of ozone and the possibility of environmental damage.

The walls of the cabinet can be formed of a transparent or opaque material resistant to ozone deterioration. Within the cabinet are means for accepting sports equipment, and in one embodiment, foraminous shelves may be provided. Naturally, hooks and other types of retainers may be utilized for any specialized equipment.

A preferred means of circulating the ozone containing air through the cabinet preferably comprises a pair of reversible fans located within the bottom wall of the cabinet defining the space for receiving the sports equipment. Such fans are known in the art and need not be described in detail herein.

Preferably, the apparatus also includes means for spraying a fluid and preferably a liquid containing a product which will assist in depleting the ozone in the cabinet.

In operation, the sports equipment to be sanitized is placed within the cabinet and the access opening closed. Subsequently, ozone containing air is circulated in a first direction throughout the cabinet from the first one of said conduits and exits through a second one of said conduits. This is continued for a period of time which, in the preferred embodiment, would range between 5 and 15 minutes and more preferably, approximately 10 minutes.

Subsequently, the ozone containing air is circulated in a second direction from the second conduit and exiting through the first conduit. This is continued for a period of time which preferably is similar to those times in which it is circulated in a first direction.

Subsequently, an ozone depleting agent is lightly sprayed and the cabinet is maintained closed for a period of time sufficient for the ozone level to go down to at least 3 ppm and preferably below 2 ppm. The cabinet can then be opened and the sports equipment removed.

As aforementioned, preferably an ozone depleting agent is sprayed into the cabinet. While there are many compounds and compositions which are known to function as an ozone depleter, a particularly preferred embodiment utilizes a tea tree oil also know as a melaleuca oil. The advantage of such an oil is that it acts as a disinfectant.

In a preferred embodiment of the invention, the ozone depletion agent may be placed on a container and there may be provided means to ensure that the agent is dispersed at a certain time prior to opening of the doors. Such control means are well known in the art and may include suitable timers and interlocks, as well as means to ensure that the ozone depleting agent is present in the container.

The cabinet may be formed of two sections—an upper section and a lower section. Various arrangements are possible including the upper wall of the lower section forming the base for the upper section or alternatively, the upper section may be provided with its own floor or base.

The components per se are well known in the art and need not be described herein. Thus, ozone generators, fans and the like are readily available from commercial suppliers.

### BRIEF DESCRIPTION OF THE DRAWINGS

Having thus generally described the invention, reference will be made to the accompanying drawings illustrating an embodiment thereof, in which:

FIG. 1 is a perspective view of a sanitizing cabinet according to an embodiment of the present invention; and

FIG. 2 is a front elevational view thereof illustrating use of the sterilizing cabinet.

### DESCRIPTION OF THE PREFERRED EMBODIMENTS

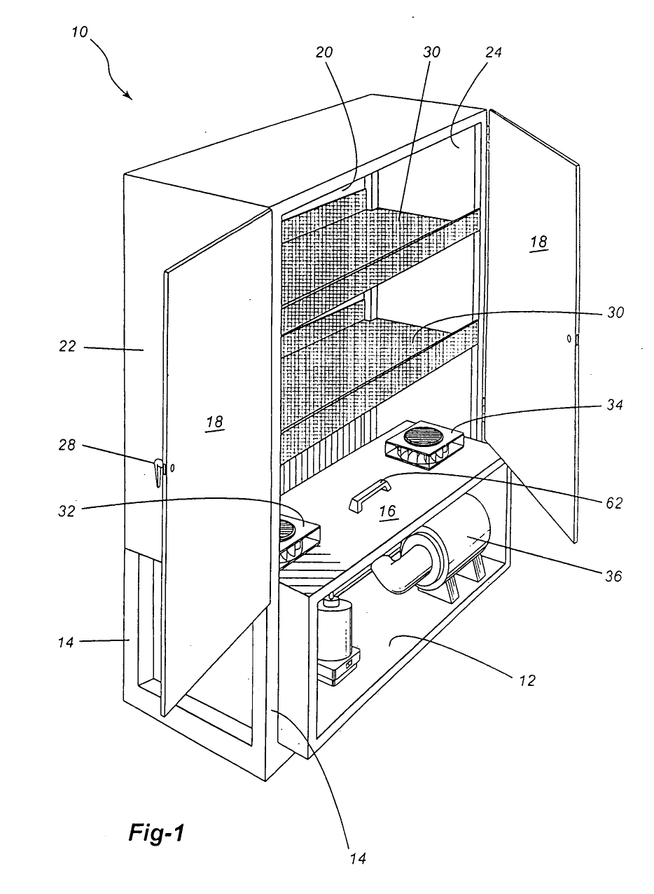

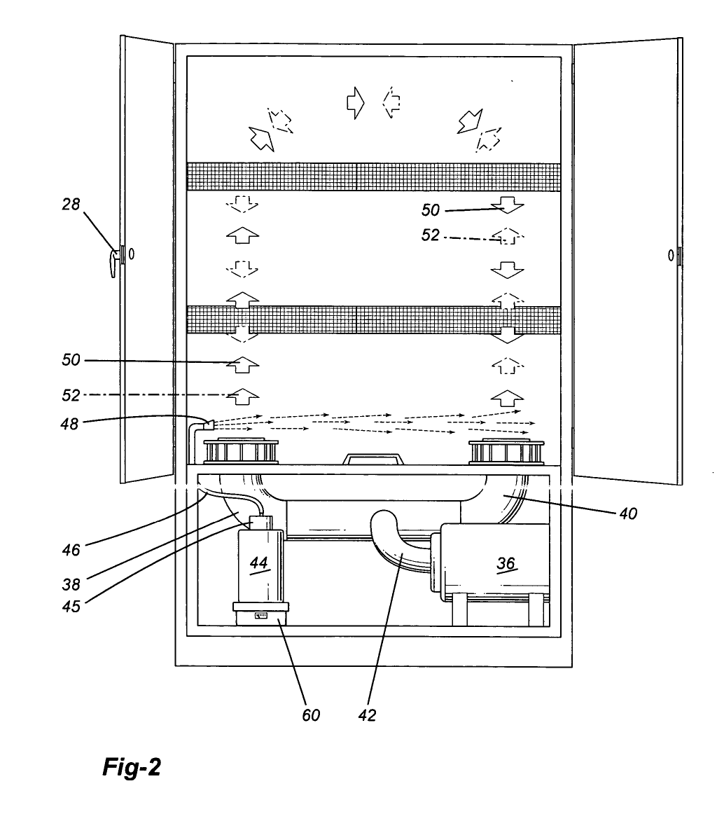

As shown in FIGS. 1 and 2, there is provided a sterilizing cabinet which is generally designated by reference numeral 10. Sterilizing cabinet 10 includes a lower section 12 and four structural uprights 14 extending upwardly.

An upper section is defined by a floor 16, a front panel 18, a rear panel 20, and a pair of side panels 22, 24. As will be seen in FIG. 1, there are also a pair of front panels 18 which are hingedly connected. When closed, a locking handle 28 is designed to engage the other front panel 18 to maintain the compartment tightly sealed.

Placed within sanitizing cabinet 10 above floor 16 are a pair of foraminous shelves 30. Foraminous shelves 30 may be of various types of structures, either a mesh or using wires.

Mounted in floor 16 is a first fan assembly 32 which is adjacent side wall 22 and a second fan assembly 34 which is adjacent side panel 24.

Mounted in the lower portion of sanitizing cabinet 10 below floor 16 is an ozone generator 36.

A first conduit 38 is in fluid communication with first fan assembly 32 while a second conduit 40 is in fluid communication with second fan assembly 34. A connecting conduit 42 is connected to ozone generator 36 and is designed to supply both first conduit 38 and second conduit 40.

A reservoir 44 is provided to contain a supply of an ozone depleting agent having one or more additives therein. The reservoir 44 is connected through compressor 45 to conduits 46 and then spray head 48 mounted in the lower portion of the upper section. A control panel (not shown) may contain conventional control circuitry including timers and interlocks. In this respect, there is provided a scale 60 which is designed to continually monitor the weight of reservoir 44 to ensure that the ozone depleting agent is present in a quantity sufficient to be sprayed within the cabinet. Naturally, other methods such as sensors within the reservoir 44 may be utilized. In all instances, lack of the presence of the ozone depleting agent would not permit operation of the apparatus.

In operation, and as shown by arrows 50, first fan assembly 32 is driven in a first direction to circulate the ozone containing air from first conduit 38 to a second conduit 40. Subsequently, the direction of circulation is reversed by reversing the directions of first and second fan assemblies 32 and 34 respectively. It will be noted that the ozone containing air circulates throughout the cabinet in order to ensure that it contacts all the equipment placed therein.

Following the treatment with ozone, an ozone depleting agent, preferably tea tree oil is then sprayed. The nozzle 48 is designed such that the tea tree oil is not sprayed on the equipment, but rather across the fan assemblies 32, 34.

The bottom may be removed as a unit by means of handle 62 to facilitate servicing.

It will be understood that the above described embodiment is for purposes of illustration only and that changes or modifications may be made thereto without departing from the spirit and scope of the invention.

1. An apparatus suitable for sanitizing sports equipment, the apparatus comprising:
a cabinet having an access opening thereto, means for sealing said access opening to provide a substantially airtight container;
means for generating ozone;
circulation means for causing said ozone to circulate within said cabinet; and
spray means for spraying a liquid proximate said circulation means.

2. The apparatus of claim 1 wherein said cabinet has an upper section and a lower section, said means for generating ozone, said spray means and said circulation means being located in said lower section.

3. The apparatus of claim 2 further including a compressor operatively connected to said spray means.

4. The apparatus of claim 1 further including fluid sensing means operative to determine when fluid is present in said fluid storage means, an interlock means to prevent operation of said means for generating ozone when a lack of fluid is detected.

5. The apparatus of claim 2 wherein said circulation means includes first and second conduits in said lower section, said first and second conduits each being connected to said means for generating ozone, each of said first and second conduits having an outlet proximate a lower portion of said upper section, each of said outlets having a fan assembly associated therewith for circulating ozone containing air.

6. The apparatus of claim 5 further including a plurality of foraminous shelves placed within said cabinet to accept said sports equipment.
